(19) United States
(12) Patent Application Publication
(10) Pub. No.: US 2002/0128912 A1
(43) Pub. Date: Sep. 12, 2002

(54) Method and apparatus for micropayment in payment transactions via mobile radio or data networks

(76) Inventor: Per Vindeby, Muenchen (DE)

Correspondence Address: BELL, BOYD & LLOYD, LLC, P. O. BOX 1135, CHICAGO, IL, 60690-1135, US

(21) Appl. No.: 10/077,035

(22) Filed: Feb. 14, 2002

(30) Foreign Application Priority Data
Feb. 15, 2001 (DE) 101 07131.0

(51) Int. Cl. G06F 17/60

(52) U.S. Cl. 705/16

(57) ABSTRACT

Method and apparatus for micropayment in payment transactions via mobile radio or data networks, wherein the user is provided the opportunity both to accept the “basic charge” and at the same time to reserve a larger sum for the desired service.

### BACKGROUND OF THE INVENTION

Payment transactions are typically based on single payment requests (for example, when shopping) or repeated payment requests (for example, telephone calls).

The e- (electronic) and m- (mobile) commerce environments, that is to say purchasing using a PC over the Internet or using a mobile terminal and the mobile radio network, have recently become more and more significant. For services such as games, information, videos or music, charges are calculated normally on a use-oriented, time-oriented or volume-oriented basis (for example, the quantity of bytes). Such services often cost only a very small sum of money (often less than 1.00). This is also referred to as a “micro-payment”.

Thus, the problem with such “e-services” is that small charge sums are debited on a repetitive basis (for example, 0.10 every 10 seconds), and the user does not then wish to confirm or even authorize every payment transaction (for example, by entering a PIN).

On the other hand, the user does wish to continue to maintain control over his/her expenditure. This is particularly important in the case of more complex payment scenarios; for example, when a charge is levied for a service on the basis of a combination of time and volume.

It is also possible that the user does not trust the service provider because he/she does not know the provider well enough. The service provider often will be independent of the user's payment service provider. In this case, it is an advantage if the user can limit the level of the payment sum which the payment service provider can pay to the service provider from his/her account.

In current solutions using continuous charging for micropayment, the user does not confirm every payment transaction. A known service for regular calculation of charges is the telephone service, for which the user is charged on the basis of time and distance; for example, 0.30 per minute. Thus, the user determines the level of cost by the length of the call, on the basis of the charge. Although the telephone providers' tariff models are becoming more and more complex (for example, a discount after a telephoning period of over ten minutes), it is still relatively easy for the user to calculate his/her expenditure. In addition, the user's level of trust in the service provider is very high in this case; the user is confident of not being charged more than he/she owes.

Only with public telephones, which involve payment in cash, can the user really control his/her expenditure, since only a certain amount of money is put into the machine. However, this method cannot be used over the Internet for payment transactions for e-services in an e-commerce environment. In addition, the user's level of trust in the service provider will not be as great as in the case outlined above, since there is generally no contractual agreement with those offering their services over the Internet.

### SUMMARY OF THE INVENTION

It is, therefore, an object of the present invention to provide users with a procedure for paying for e-services and digital goods on the following basis:

the user will maintain control over cost

repeated debiting will be made possible

simple and convenient use

flexible setting of expenditure limits

simple implementation.

Accordingly, in an embodiment of the present invention, a method is provided for payment transactions via mobile radio networks or data networks, wherein the method includes the steps of: confirming, by a user, debit sums for use of a service; approving, by the user, a total monetary unit prior to use of the service; transferring, repeatedly, first monetary units from an account of the user to an account of a service provider; and debiting, repeatedly, the first monetary unit without further request for approval to the user, as long as a total debited amount is covered by the total monetary unit in the account.

In an embodiment, the method further includes the step of reserving the total monetary unit for use of a particular service, such that the user is guaranteed a corresponding period of use of the particular surface.

In an embodiment, the method further includes the step of releasing a remaining balance of the total monetary unit, with use of the particular service has ended, for other services.

In an embodiment, the method further includes the step of terminating use of the service if the total debited amount would exceed the total monetary unit upon debiting a next first monetary unit.

In an embodiment, the method further includes the step of restricting use of the service if the total debited amount would exceed the total monetary unit upon debiting a next first monetary unit.

In another embodiment of the present invention, a method is provided for payment transactions via mobile radio networks or data networks, whereupon a user wishes to use a service belonging to a service provider wherein the method includes the steps of: sending a first payment request, via the service provider, to the user for the service; notifying the service provider, by the user, in a payment confirmation, of a total monetary unit confirmed prior to use of this service for use of this service; and calculating, repeatedly, charges for use of the service for the user at particular intervals of time, with first monetary units being repeatedly transferred from the account of the user to an account of the service provider.

In an embodiment, the method further includes the steps of performing payment transactions via a payment service provider, registering the user with the payment service provider, registering the service provider with the payment service provider, sending a first payment request from the service provider to the payment service provider for use of the service, and sending a second payment request from the payment service provider to the user.

In an embodiment, the method further includes the step of ceasing the forwarding of a further payment request to the user if the total monetary unit is sufficient for a debit operation.

In an embodiment, the method further includes the step of releasing the total monetary unit if the first monetary unit is not debited further over a particular period of time.

In an embodiment of the method, the payment confirmation includes entry of a PIN or a suitable password.

In a further embodiment of the present invention, an apparatus is provided for effecting payment transactions via mobile radio networks or data networks, wherein the apparatus includes parts for: confirming, by a user, debit sums for use of a service; approving, by the user, a total monetary unit prior to use of the service; transferring, repeatedly, first monetary units from an account of the user to an account of a service provider; and debiting, repeatedly, the first monetary unit without further request to the user, as long as a total debited amount is covered by the total monetary unit in the account.

In yet another embodiment of the present invention, an apparatus is provided for effecting a method for payment transactions via mobile radio networks or data networks, whereupon a user wishes to use a service belonging to a service provider, wherein the apparatus includes parts for: sending a first payment request, by the service provider, to the user for the service; notifying the service provider, by the user, in a payment confirmation, of a total monetary unit confirmed prior to use of this service for use of this service; and calculating, repeatedly, charges for use of this service for the user at particular intervals of time, with first monetary units being repeatedly transferred from an account of the user to an account of the service provider.

Additional features and advantages of the present invention are described in, and will be apparent from, the following Detailed Description of the Invention and the Figures.

### BRIEF DESCRIPTION OF THE FIGURES

FIG. 1 shows a flow diagram for “pre-confirming” a sum of money for e-commerce.

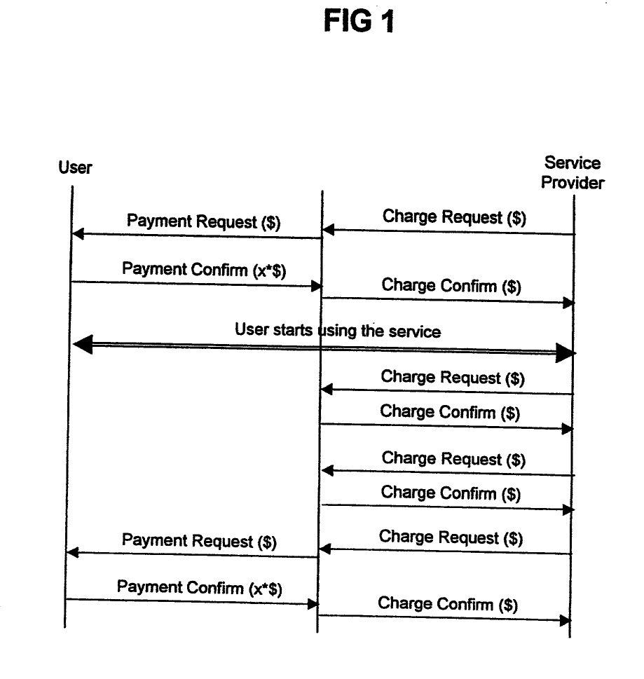

### DETAILED DESCRIPTION OF THE INVENTION

To describe the present invention, the following roles are assigned:

Service provider (Service Provider): provides an e-service, such as digital “goods” like music, information or games. Receives income from the services provided to the user.

Payment service provider (Payment Provider): provides the payment service. Generally, the user and the service provider are registered with the payment provider. To perform a payment transaction, the sum of money is debited from the user's account and the sum of money is credited to the service provider's account.

User (User): uses a service belonging to the service provider. Pays the service provider for the services used via the payment service provider.

The following messages are sent between the 3 parties:

Calculation of charge (Charge Request/Confirm): a “Charge Request” is a message from the service provider to the payment service provider, which message will be used to debit a particular sum from the user's account and to credit it to the service provider's account. The request is confirmed back to the service provider via a “Charge Confirm”.

payment transaction (Payment Request/Confirm): a “Payment Request” is a message sent from the payment service provider to a user, which message is used to request a sum of money for paying for a service. The user accepts the payment with a “Payment Confirm” message.

The user receives a payment request before he/she can use a service belonging to a service provider or in order to continue to use a service. The user is, therefore, requested to use the payment service provider to confirm or authorize a payment transaction before being allowed to use the required service. The service provider triggers the payment by sending a “Charge Request” to the payment service provider.

In the case of repeated charging, the user is repeatedly requested during use to make a payment (for example, every 10 seconds while MP3 data are being downloaded). These subsequent “Charge Requests” are likewise triggered by the service provider by sending “Charge Request” messages to the payment service provider. However, the user does not wish to confirm or authorize every one of these payment requests (Charge Request). On the other hand, the user does wish to be able to limit and control the expenditure for this service.

If the user now wishes to use a service, he/she is notified about the initial charge for the service via a “Payment Request”. This charge may be, by way of example, 0.10 for 30 seconds of MP3 music which, by way of example, might at the same time be the minimum charged for the service by the service provider. The user can accept this sum and would, in this case, be asked again after 30 seconds whether he/she accepts the next payment transaction. This procedure is not particularly user-friendly, however.

The present invention thus proposes the following improved method: The user has the option of accepting both the initial charge and at the same time a larger sum for this service. By way of example, the user can accept a payment of up to 2.00, although this service initially requires only a charge of 0.10. However, to begin with, the user is still charged only 0.10; his/her account then still contains a service-specific credit, confirmed beforehand, of 1.90. If the payment service receives the next “Charge Request” from the service provider, it knows that the user has already confirmed the sum in advance. If the service-specific credit is sufficient, the payment service provider will debit the sum from the user's account without asking for confirmation or authorization by the user. Only if the sum of money confirmed in advance is not sufficient is the user again asked whether he/she is ready to confirm the payment.

For each payment request received by the user, the user is able to make a fresh decision about the level of the sum confirmed in advance. He/she can confirm either the exact sum demanded by the service provider or else a larger sum. Typically, a multiple of the requested sum will be appropriate. If the user confirms a smaller sum (for example, 0), the service provider will terminate the user's use of the service or permit only restricted use.

If the user accepts a larger sum than the one requested, the excess portion of the sum accepted can be reserved for this service by the payment service. In this case, the user has the guarantee that there is sufficient money for using the service. If this sum is confirmed but not reserved, the procedure provides the user with convenient expenditure control, since the user can set a limit. In this case, however, a “Charge Request” from the service provider can be rejected if the user's account does not afford sufficient coverage; e.g., because other chargeable services are being used at the same time.

If the user terminates use of the service, the service provider should communicate this to the payment service provider, with the result that the latter releases the sum confirmed beforehand again. In addition, the payment service provider may have a time monitor which releases the sum of money confirmed beforehand or reserved after a particular time interval without any account movements. If the payment service provider receives an unexpected (because it is too late) “Charge Request” for this service after the sum of money confirmed in advance has been released again, the user needs to confirm this sum of money again.

Advantages

The method of the present invention allows the service providers to use continuous charging (e.g., based on time or volume) without the need for the user to confirm every request separately.

Depending on the payment policy of the payment service provider or in the user profile, the user can be requested to authorize the payment either using a password (PIN, Private Identification Number) or simply via an “OK”.

The user has a high level of flexibility, since he/she can always redefine the sum of money confirmed in advance.

This introduces cost control for the user; only if the defined restriction has been exceeded is the user asked for confirmation again.

Only the user and the payment service provider see the advance confirmation of the larger sum, but not the service provider. The service provider is thus not able to check what sum the user is ready to spend on the chosen service. In this case, it is appropriate for the payment service provider to be arranged “between” the user and the service provider. This has no effect on the implementation, however.

If the method is used only to reduce the number of requests to the user, it is not necessary to reserve the sum. If this sum confirmed in advance is greater than zero at the time at which the user terminates use of the service, the payment service provider can easily delete the remaining sum confirmed in advance. This is not time-critical and also can be implemented by an “Inactivity-Timer” (that is to say, no further account movements since a particular time.)

In the other case, when the advance confirmation is also intended to get the provision of a sufficient sum of money for using the service, the payment service provider will reserve the money for this purpose. It is then crucial for the remaining balance sum to be released immediately after use has ended.

Although the method for micropayments has been developed in an e-commerce and m-commerce environment, other fields of application are conceivable.

The method is easy to implement for the payment service provider.

The user interface for the user can be kept very simple.

The user can set a payment limit in a very simple and flexible manner. The level can be changed with each new request for confirmation.

The service provider and the payment service provider can be organizations which are independent of one another.

Although the present invention has been described with reference to specific embodiments, those of skill in the art will recognize that changes may be made thereto without departing from the spirit and scope of the invention as set forth in the hereafter appended claims.

1. A method for payment transactions via at least one of mobile radio networks and data networks, the method comprising the steps of:
confirming, by a user, debit sums for use of a service;
approving a total monetary amount, by the user, prior to use of the service;
transferring, repeatedly, first monetary units from an account of the user to an account of a service provider; and
debiting, repeatedly, the first monetary unit without further requests for approval to the user, as long as a total debited amount is covered by the total monetary unit in the account.

2. A method for payment transactions via at least one of mobile radio networks and data networks as claimed in claim 1, the method further comprising the step of reserving the total monetary unit for use of a particular service, such that the user is guaranteed a corresponding period of use of the particular service.

3. A method for payment transactions via at least one of mobile radio networks and data networks as claimed in claim 2, the method further comprising the step of releasing a remaining balance of the total monetary unit, when use of the particular service has ended, for debiting for other services.

4. A method for payment transactions via at least one of mobile radio networks and data networks as claimed in claim 1, the method further comprising the step of terminating use of the service if the total debited amount would exceed the total monetary unit upon debiting a next first monetary unit.

5. A method for payment transactions via at least one of mobile radio networks and data networks as claimed in claim 1, the method further comprising the step of restricting use of the service if the total debited amount would exceed the total monetary unit upon debiting a next first monetary unit.

6. A method for payment transactions via at least one of mobile radio networks and data networks, wherein a user wishes to use a service belonging to a service provider, the method comprising the steps of:
sending a first payment request for the service from the service provider to the user;
notifying the service provider, by the user, in a payment confirmation, of a total monetary unit confirmed prior to use of the service for use of the service; and
calculating, repeatedly, charges for use of the service for the user at particular intervals of time, with first monetary units being repeatedly transferred from an account of the user to an account of a service provider.

7. A method for payment transactions via at least one of mobile radio networks and data networks as claimed in claim 6, the method further comprising the steps of:
performing payment transactions via a payment service provider;
registering the user with the payment service provider;
registering the service provider with the payment service provider;
sending a first payment request for use of the service from the service provider to the payment service provider; and
sending a second payment request from the payment service provider to the user.

8. A method for payment transactions via at least one of mobile radio networks and data networks as claimed in claim 6, the method further comprising the step of ceasing the forwarding of a further payment request to the user if the total monetary unit is sufficient for a debit operation.

9. A method for payment transactions via at least one of mobile radio networks and data networks as claimed in claim 6, the method further comprising the step of releasing the total monetary unit if the first monetary unit is not debited further over a particular period of time.

10. A method for payment transactions via at least one of mobile radio networks and data networks as claimed in claim 6, wherein the payment confirmation includes entry of at least one of a PIN and a suitable password.

11. An apparatus for effecting a method for payment transactions via at least one of mobile radio networks and data networks, the apparatus comprising:
means for confirming, by a user, debit sums for use of a service;
means for approving, by the user, a total monetary unit prior to use of the service;
means for transferring, repeatedly, first monetary units from an account of the user to an account of a service provider; and
means for debiting, repeatedly, the first monetary unit without further requests for approval to the user, as long as a total debited amount is covered by the total monetary unit in the account.

12. An apparatus for effecting a method for payment transactions via at least one of mobile radio networks and data networks, wherein a user wishes to use a service belonging to a service provider, the apparatus comprising:
means for sending a first payment request for the service from the service provider to the user;
means for notifying the service provider, by the user, in a payment confirmation, of a total monetary unit confirmed prior to use of the service for use of the service; and
means for calculating, repeatedly, charges for use of the service for the user at particular intervals of time, with first monetary units being repeatedly transferred from an account of the user to the account of the service provider.
